(19) United States
(12) Patent Application Publication
(10) Pub. No.: US 2012/0319365 A1
(43) Pub. Date: Dec. 20, 2012

(54) PARALLEL POWER CHUCK

(76) Inventors: Thomas Michael Grobbel, Ortonville, MI (US); Ryan Lynn Wejrowski, Traverse City, MI (US); Thomas Allen Borysiak, Traverse City, MI (US); Daniel Ray Duell, Traverse City, MI (US); Brian J. Crowley, Elk Rapids, MI (US)

(21) Appl. No.: 13/161,595

(22) Filed: Jun. 16, 2011

(51) Int. Cl. B23B 31/16; B23B 31/12

(52) U.S. Cl. 279/121; 279/137; 279/110

(57) ABSTRACT

A parallel power chuck for clamping two ends of a shaft or similar workpiece for machining using two centering mechanisms. The centering mechanisms independently operate from a single internal actuation mechanism and clamp each end of the shaft regardless of shaft size from end to end. The internal actuation mechanism further equalizes applied clamping force after compensating for size variation.

### CROSS-REFERENCE TO RELATED APPLICATION

None.

### BACKGROUND OF THE INVENTION

I. Field of the Invention

The present disclosure relates generally to a power chuck. In particular, the present disclosure is directed to a parallel power chuck having side by side centering mechanisms in a single assembly to clamp a workpiece on both ends with very high centering accuracy.

II. Description of the Prior Art

In machines that operate on a rotating workpiece, such as lathes and the like, the workpiece is typically held in a chuck to rotate the workpiece relative to a tool (such as a blade) so that the tool can operate on the workpiece. The chuck, which is comprised of multiple movable or adjustable jaws, exerts a force on the workpiece to secure or clamp the workpiece in the chuck between the jaws.

Conventionally, power or force-actuated chucks include a chuck body mounted upon a head stock spindle of a machine tool. The chucks generally carry a plurality of chuck jaws which are radially displaceable in respective guides inwardly and outwardly, respectively, to engage a workpiece or to disengage therefrom. The jaws are actuated by an axially displaceable piston within the chuck body. Typically, each jaw includes a wedge which corresponds with a cooperating wedge on the piston whereby as the wedge surfaces engage in the axial direction, the jaws move in radial and circumferential directions in their respective guides.

Many cylindrical (for example) workpieces need to be machined while in parallel relation (e.g. to the bed or like of a machine tool). The current industry method for machining these types of pieces is to load the shaft into a so-called fixed vee-block and clamp down over the top of the shaft. However, the use of a vee-block does not accommodate for piece variation. In other words, a shaft with a high limit part diameter on one side will rest higher in the vee-block than the low limit diameter on the other side. The result is that the center line of the shaft, or the position of the workpiece that is to be machined, will be off center.

Accordingly, it is a general object of this disclosure to provide a power chuck that will maintain the same centerline regardless of workpiece size variation.

It is another general object of this disclosure to provide a power chuck assembly that utilizes two jaw centering mechanisms side by side, or in parallel, in a single unit to clamp a shaft or similar workpiece on both ends with very high centering accuracy.

It is a more specific object of this disclosure to provide a power chuck assembly that utilizes two parallel jaw centering mechanisms that independently compensate for variations in workpiece size.

It is another more specific object of this disclosure to provide a power chuck assembly that utilizes two parallel two-jaw centering mechanisms that equalize the clamping force exerted by each set of jaws on the workpiece after compensating for workpiece size variations.

These and other objects, features and advantages of this disclosure will be clearly understood through a consideration of the following detailed description.

### SUMMARY OF THE INVENTION

According to an embodiment of the present invention, there is provided a parallel power chuck for clamping portions of a workpiece. The chuck having an assembly housing with a front face and a centerline. A first set of jaws is radially displaceable, perpendicular to the centerline and clamps a first portion of the workpiece, while a second set of jaws is adjacent the first set and also radially displaceable, perpendicular to the centerline and clamps a second portion of the workpiece.

There is also provided a parallel power chuck for clamping portions of a workpiece, the chuck having an assembly housing with an axis through a front face. A primary axial movement member is rotatably coupled to a stabilizing member inside the housing. A pair of secondary axial movement members are also rotatably coupled to the stabilizing member and are further operatively coupled to a set of radially moveable jaws, relative said face, for clamping portions of the workpiece whereby the rotatable couplings of the stabilizing member enable independent clamping of the portions of the workpiece.

There is further provided a parallel power chuck for clamping two ends of a generally cylindrical workpiece. The chuck having an assembly housing with an axis through a front face. A collar is positioned within the housing for coupling the assembly to a driver for axial movement. A primary spheroidal joint couples the collar to an actuator and secondary spheroidal joints couple respective wedge bolts to the actuator. The wedge bolts are then operatively coupled to respective sets of radially movable jaws relative the front face of the chuck.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is a perspective view of a parallel power chuck assembly according to the principles of an embodiment of the present disclosure.

FIG. 2 is a top plan view of the parallel power chuck assembly of FIG. 1.

FIG. 3 is a cross-sectional view of the parallel power chuck assembly taken along line 3-3 of FIG. 2.

FIG. 4 is a cross-sectional view of the parallel power chuck assembly taken along lines 4-4 of FIG. 2.

FIG. 5 is a perspective view of the parallel power chuck assembly of FIG. 1 adapted to receive a noncylindrical workpiece.

FIG. 6 is a top plan view of the parallel power chuck assembly of FIG. 5.

### DESCRIPTION OF THE PREFERRED EMBODIMENTS

The following description of the preferred embodiments is merely exemplary in nature and is in no way intended to limit the disclosure, its application or use.

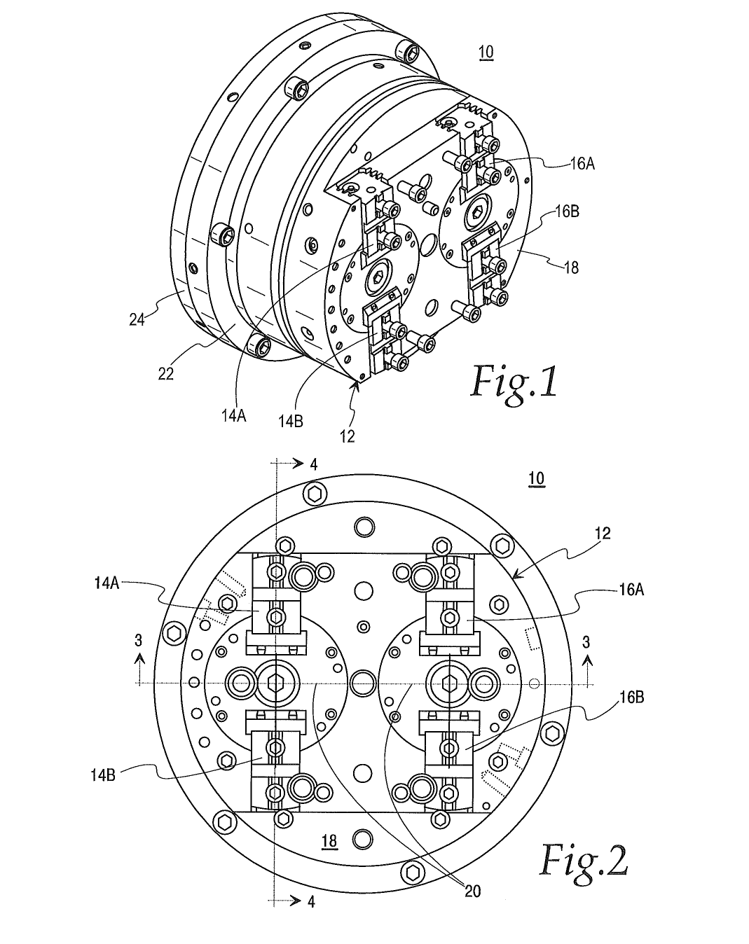

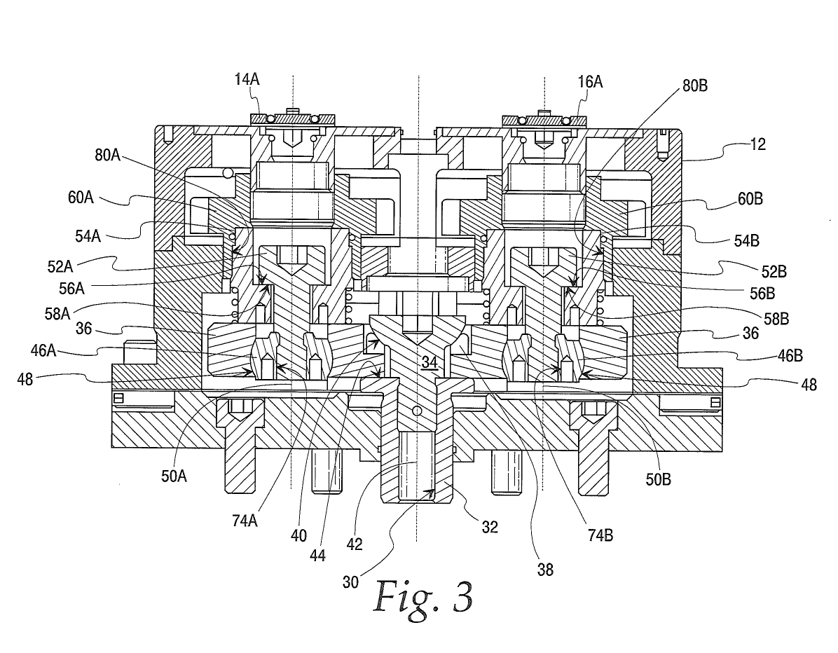

With reference now to the drawings, and in particular FIGS. 1 and 2, a parallel power chuck assembly 10 includes a housing subassembly 12 for housing two parallel sets of chuck components side by side. By way of example, these chuck components can be an industry standard, such as ITW-Forkardt 2QLC-LS-250, a more conventional Buck™ chuck jaw and wedge profile, a lever mechanism chuck, or a chuck of a more custom design. In any event, the components include a first set of master jaws 14A, 14B and an adjacent second set of master jaws 16A, 16B. These cooperating sets of master jaws are designed to clamp on a portion of a workpiece that is parallel to the chuck face 18 on a centerline 20. When the chuck is actuated, the jaws 14, 16 will stroke towards centerline 20 to clamp and load the workpiece and then, after the machining is completed, away from the centerline 20 to unload the workpiece.

The subassembly 12 is mounted to a backplate 22 which can then be mounted to a spindle adaptor 24, in the case of a machine lathe, or on a milling machine. Whether the chuck is rotated for machining of the workpiece on the same centerline as the spindle rotation, or the chuck is mounted and the machines cutting tools are rotated, the parallel chuck provides for high centering accuracy regardless of the variation of workpiece shaft size from one end to the other.

For example, if the shaft of a workpiece has a diameter of 1.000+/−0.005″, the jaws 14, 16 must have the ability to clamp on the entire part range of 1.005−0.995″ diameter. In a worst case scenario, the first set of jaws 14 may have to grip on a 1.005″ diameter and the second set of jaws 16 may have to grip on a 0.995″ diameter. In this case, the first set of jaws 14 will clamp the 1.005″ diameter first, and then internal actuator must then compensate to allow the second set of jaws 16 to continue to stroke inward until they clamp the 0.995″ diameter. Once the mechanism compensates and both ends of the shaft are clamped, the mechanism then equalizes the clamping forces of both jaws 14, 16.

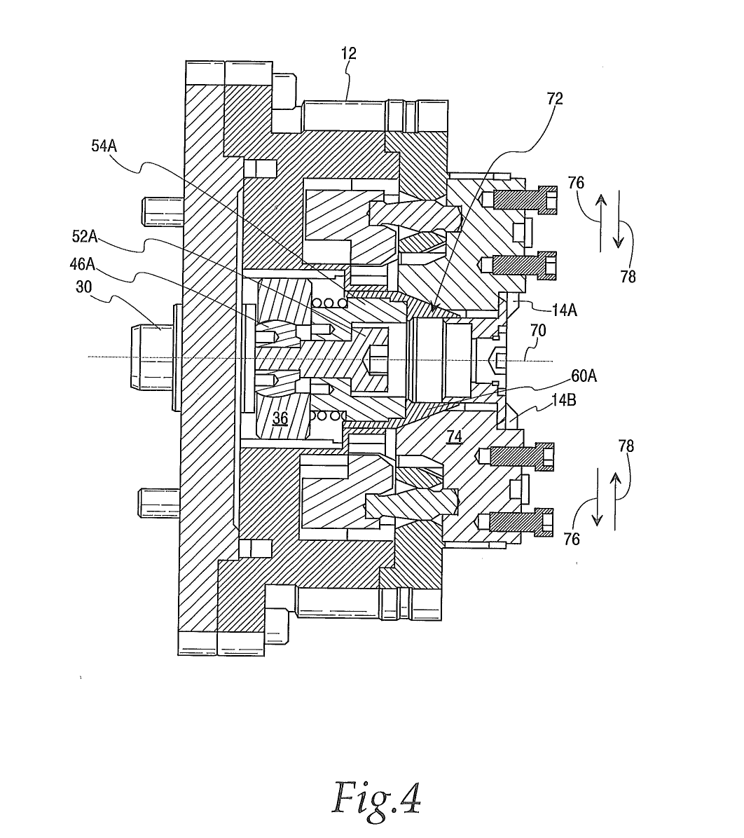

The preceding generalized summary will now be more particularly detailed with regard to FIGS. 3 and 4 and the use of the parallel power chuck on a spindle, wherein FIG. 3 is a cross-sectional view of the power chuck assembly taken along lines 3-3 of FIG. 2 and FIG. 4 is a cross-sectional view of the power chuck assembly taken along lines 4-4 of FIG. 2. Turning first to FIG. 3, the spindle adapter mounts the parallel power chuck onto a lathe (not shown) and the hydraulic cylinder of the lathe is connected to the chuck via a thread in the inner diameter 30 of a primary axial movement member or drawbolt lock collar 32. As will be described herein, it is this connection which actuates the entire mechanism because a drawbolt 34 is also threaded into the drawbolt lock collar 32.

The drawbolt 34 extends axially thru a stabilizer plate or actuator 36 and a drawbolt washer 38 thereby creating a spherical radius mating surface 40 between the drawbolt 34 and the drawbolt washer 38. This spherical radius mating surface 40 creates a primary spheroidal joint and allows the actuator 36 to rotate, barring any further encumbrances, at almost any angle about the center axis 42 of the parallel power chuck 10. Accordingly, when the hydraulic cylinder is energized and the drawbolt lock collar 32 is pushed axially, it also pushes the drawbolt 34 which pushes the drawbolt washer 38 and actuator 36 via the flanged face 44 of the drawbolt lock collar 32.

Actuator 36 extends to both sides of the housing subassembly 12 and connects to each of the spherical bearing 46A of the first jaws 14 and the spherical bearing 46B of the second jaws 16. This connection creates another spherical radius mating surface 48 between the bearing 46 and the actuator 36. This spherical radius mating surface 48 creates a secondary spheroidal joint and allows the actuator 36 to rotate, barring any further encumbrances, at almost any angle about the center axis 50A, 50B of the spherical bearing 46.

The spherical bearings 46A, 46B are connected to secondary axial movement members or wedge bolts 52A, 52B thru a threaded connection (74A, 74B). The wedge bolts 52A and 52B extend thru a respective chuck connector 54A, 54B whereby, the shoulder 56A, 56B of the wedge bolt 52A, 52B mates with the counter bore face 58A, 58B of the chuck connector 54A, 54B. The chuck connector 54A, 54B is connected to a wedge 60A, 60B thru a threaded connection (80A, 80B). Accordingly, when the drawbolt lock collar 32 is pushed or pulled axially, it will move all connecting component parts, drawbolt 34, drawbolt washer 38, actuator 36, spherical bearing 46, wedge bolt 52, chuck connector 54 and wedge 60 in the same direction.

Turning now to FIG. 4 and the movements of the jaws 14. This cross-sectional view depicts the spherical bearing 46A, the wedge bolt 52A and the chuck connector 54A in the center of the view, directly on the center axis 70 of the wedge bolt. The wedge 60A has an angle 72, which is preferably at 22°, but will depend upon particular chuck design needs. In any event, the wedge 60A is connected to the master jaw 14 thru a conventional tee-slot connection at the 22° wedge angle. The interaction between the wedge 60A and the master jaw 14 are well known and understood in the field of power chucks and will not be detailed herein. For purposes of this disclosure, when the drawbolt lock collar is pushed by the hydraulic cylinder, all of the mating components are also pushed as previously discussed. When wedge 60A is pushed, it pushes master jaws 14, and therefore clamping jaws (infra) outward 76 and in the open position. Similarly, when the drawbolt lock collar is pulled by the hydraulic cylinder, all of the mating components are also pulled so when the wedge 60A is pulled, it pulls master jaws 14 and therefore clamping jaws (infra) inward 78 to the clamping position.

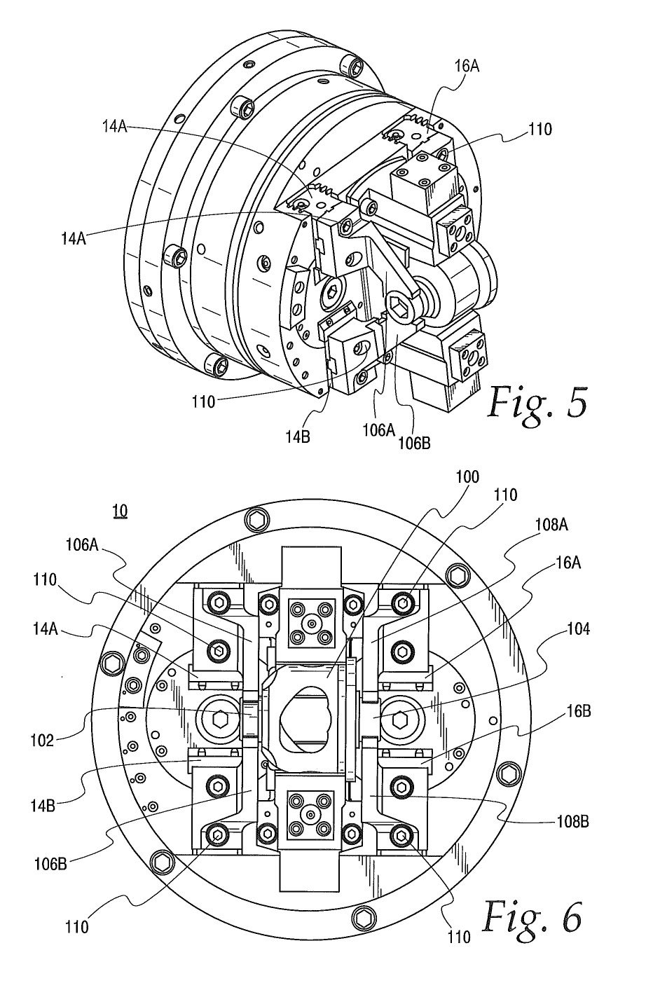

Referring now to FIGS. 5 and 6, the parallel power chuck will now be shown and described as it clamps a non-cylindrical workpiece 100 having a shaft on the left, or a first shaft 102, and a shaft on the right, or a second shaft 104. In this particular example, the master jaws 14, 16 are coupled to a set of clamping jaws 106A, 106B and 108A, 108B via bolts 110, although other forms of clamping jaws can be used. Following the sequence as described in the previous sections, when the drawbolt lock collar 32 is pushed or pulled, it will move clamping jaws 106 and 108 inward or outward through the internal mechanism. If the left and right shafts of the workpiece to be clamped are not equally sized, the parallel power chuck has the ability to compensate and eventually applies an equal clamping force to both shafts.

Following the previously described example for workpiece 100, the first shaft 102 will have the 1.005″ diameter and the second shaft 104 will have the 0.995″ diameter. During the clamping cycle, drawbolt lock collar 32 is pulled downward via the hydraulic cylinder, and when the clamping jaws 106 have clamped the 1.005″ diameter part on the left side of the shaft, then clamping jaws 106, master jaws 14, wedge 60A, wedge bolt 52A and spherical bearing 46A all stop moving on the left side of the chuck. However, as the actuator 36 pivots around the center axis 50A of the spherical bearing 46A on the left side of the chuck, the lock collar 32 continues to pull the drawbolt 34, drawbolt washer 38 and thus the continued movement of clamping jaws 108, master jaws 16, wedge 60B, wedge bolt 62B and spherical bearing 46B on the right side of the chuck. The spherical radius mating surfaces 40 and 48 allow for concurrent pivoting of the actuator 36 at the drawbolt and the spherical bearings thereby compensating for the different sized left 102 and right 104 shafts of the workpiece 100. This compensation allows clamping jaws 108 to continue to move inward until they clamp the 0.995″ diameter on the right side of the shaft.

After both clamping jaws 106, 108 have clamped the workpiece 100, the internal pivoting mechanism becomes static. Although the actuator 36 will now be on a slight angle due to the compensation, the spherical mating surfaces 40 and 48 allow the pulling force of the drawbolt lock collar 32 to be equally distributed between clamping jaws 106 and clamping jaws 108. The compensation for unequal shaft diameters ensures a true centering of the workpiece, while the equalization ensures the uniform application of clamping force throughout the workpiece.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention if its broader aspects, and, therefore, the aim in the appended claims is to cover all such changes and modifications as fall within the true spirit and scope of the present disclosure.

What is claimed is:

1. A power chuck for clamping portions of a workpiece, said chuck comprising:
an assembly housing having a front face with a centerline;
a first set of jaws radially displaceable, perpendicular to said centerline, for clamping a first portion of said workpiece; and
a second set of jaws, adjacent said first set of jaws, said second set of jaws radially displaceable, perpendicular to said centerline, for clamping a second portion of said workpiece.

2. A power chuck as defined in claim 1 wherein said housing includes a backplate for mounting said chuck to a machine lathe.

3. A power chuck for clamping portions of a workpiece, said chuck comprising:
an assembly housing having an axis through a front face;
a primary axial movement member within said housing;
a stabilizing member rotatably coupled to said primary member;
a first and a second secondary axial movement member rotatably coupled to said stabilizing member;
each of said secondary axial movement members operatively coupled to a set of radially moveable jaws, relative said face, for clamping portions of said workpiece whereby the rotatable couplings of said stabilizing member enable independent clamping of the portions of the workpiece.

4. A power chuck as defined in claim 3 wherein said housing includes a backplate for mounting said chuck to a machine lathe.

5. A power chuck as defined in claim 3 wherein said primary axial movement member is a drawbolt.

6. A power chuck as defined in claim 3 wherein said secondary axial movement member is a wedge bolt.

7. A power chuck as defined in claim 3 wherein said rotatable couplings include a spherical bearing coupled to said stabilizing member.

8. A power chuck as defined in claim 5 wherein said rotatable couplings include a drawbolt washer coupled to said stabilizing member.

9. A power chuck for clamping two ends of a generally cylindrical workpiece, said chuck comprising:
an assembly housing having an axis through a front face;
a collar within said housing for coupling said assembly to a driver for axial movement;
an actuator positioned within said housing;
a primary spheroidal joint for coupling said collar to said actuator;
a first and a second wedge bolt coupled to said actuator through respective secondary spheroidal joints; and
said wedge bolts operatively coupled to respective sets of radially movable jaws relative to said face.

10. A power chuck as defined in claim 9 wherein said housing includes a backplate for mounting said chuck to a machine lathe.

11. A power chuck as defined in claim 9 wherein said primary spheroidal joint includes a spherical radius mating surface between a drawbolt and a drawbolt washer coupled to said actuator.

12. A power chuck as defined in claim 9 wherein said secondary spheroidal joints include a spherical radius mating surface between a spherical bearing and a wedge bolt coupled to said actuator.
